(19) United States
(12) Patent Application Publication
(10) Pub. No.: US 2026/0266081 A1
(43) Pub. Date: Sep. 10, 2026

(54) VEHICLE PROTECTIVE SHIELD

(71) Applicant: Bruce Louis Lenzer, Albuquerque, NM (US)

(72) Inventor: Bruce Louis Lenzer, Albuquerque, NM (US)

(21) Appl. No.: 19/165,480

(22) PCT Filed: May 7, 2024
(86) PCT No.: PCT/US2024/028212

§ 371 Date: Sep. 15, 2025

Related U.S. Application Data
(60) Provisional application No. 63/500,689, filed on May 8, 2023.

(51) Int. Cl. E04H 6/04

(52) U.S. Cl. CPC E04H 6/04

(57) ABSTRACT

A protective shield (20, 120, 200) for a vehicle comprises a sealable bag adapted to completely cover major equipment such as vehicles (1). In a particular embodiment, shield (20, 120, 200) is fabricated from metallic fabric layer (503) sandwiched between protective layers (501, 505), that prevents EMP leakage from affecting vehicle (1) electronics. One or more closures (30, 300) enable separating shield (20, 120, 200) into components to facilitate handling and storage. Zipper lock (310) may couple to an embedded computer adapted to verify time and duration of usage. Resembling in one embodiment a commonplace car cover, shield (200) is flexible and light weight enough to fold and store when not in use, including stowing it in vehicle (1) during travel. In another embodiment, shield (20, 120) may comprise a structure into which vehicle (1) may be driven and sealed to optimize convenience and encourage usage thereof.

### CROSS REFERENCE TO RELATED APPLICATION

This application claims priority from U.S. Provisional Application Ser. No. 63/500,689, filed May 8, 2023. The contents thereof are incorporated by reference herein in their entirety.

### BACKGROUND OF THE INVENTION

### 1. Field of the Invention

This invention relates generally to means for protecting automobiles and other vehicles from environmental threats, and particularly to means for protecting electronic devices in such vehicles. More particularly, this invention relates to a cover for an automobile or other vehicle which shields its electronics from damage and disability due to a high-energy electromagnetic pulse (EMP).

### 2. Description of Related Art

An EMP is a high-energy electromagnetic field which typically rises abruptly and far beyond normal ambient levels. It creates high voltage and current spikes in nearby metallic objects such as electric grid wires. The spikes easily can overwhelm insulation and damage or destroy equipment and electronic devices. An EMP may be caused by any number of electromagnetic sources such as wound coils, electromagnets and the like.

A nuclear EMP is an EMP caused by detonation of a nuclear weapon, optimally occurring approximately 18 to 31 miles (30 to 50 kilometers) above ground. The weapon itself may include other damaging influences, such as pressure, heat, wind and ionizing radiation, but the focus of this invention is on the non-ionizing electromagnetic field also imposed on the immediate environment and the destructive effect it can have on electronic and electric devices and services in the area.

A nuclear EMP is understood to have three (3) distinct pulses of voltage and corresponding current. An “E1 pulse” is caused by gamma rays having energy levels of one (1) to three (3) mega electron volts (1-3 MeV) in the radio frequency range of 15 to 250 megahertz (MHz). The gamma rays penetrate the atmosphere and interact with atmospheric atoms, freeing electrons from their nuclei. The resulting ionization of the atmosphere induces abnormal, transient electric and magnetic fields and current flow through anything that acts as an antenna.

For an optimally positioned detonation and over the center of a target, the entire area, even the size of a large nation, may be affected by the E1 pulse. Released during the first few nanoseconds of the nuclear reaction, the E1 pulse continues until one microsecond (1 μsec.) after the detonation.

A second, “E-2” pulse starts at detonation-plus-one-usec and continues to ionize the atmosphere until approximately detonation-plus-one-second (1 sec). It is caused by inelastic scattering of matter (matter bouncing off other matter) from the nuclear weapon interacting with matter that makes up the atmosphere.

A third, “E-3” pulse starts at approximately detonation-plus-one-second (1 sec) and can continue for several minutes. The E-3 pulse is caused by the nuclear detonation distorting of the earth's geomagnetic structure, and then its reconfiguration. As the magnetic force lines are pushed out of configuration and then rebound back into normal configuration, electricity is generated which flows through the atmosphere until it contacts an antenna (wires).

Electric transmission and distribution grid wires within the vicinity of a nuclear explosion comprise an excellent antenna. The ionization thus produces an over-voltage condition throughout grid in the affected area. All arrays of wiring (even in individual homes and office buildings) will act as large or small antennae and will propagate the flow of electricity and over-voltage conditions.

In 1962, High Altitude Atomic Bomb testing conducted in the Marshall Islands, 1000 miles from Hawaii, caused power black outs in Hawaii and on the West Coast of California. Those systems were largely analog and thus less affected than would be current technology which is overwhelmingly digital. Devices, including myriad electronic circuits highly sensitive and susceptible, would be far more vulnerable if a discharged EMP were to occur in present day.

The intensity of a nuclear detonation's EMP is about 30,000 to 50,000 volts-per-meter-thousands of times greater than the energy from a microwave bleed-off. An energetic EMP can temporarily upset or permanently damage electronic equipment by generating high voltage and high current surges. Semiconductor components are particularly at risk. The effects of damage can range from imperceptible to the eye, to devices literally blowing apart.

Today's vehicles can have up to 50 or more computers controlling a variety of functions, including operating the main power plant (engine). Replacing such computers currently can cost from $100.00 to $1000.00 each, not including the cost of reprogramming. A deliberate detonation over the central United States could cripple the country. With the exception of radiation hardened military equipment, the propagation of an EMP event could be catastrophic, as it could shut down power grids, systems and electronics across the US, including personal and commercial equipment and all types of transportation vehicles.

For members of the general public, not having a working vehicle under such circumstances would significantly impede their ability to function, such as traveling from work to home, retrieving children from schools, seeking medical attention, and/or purchasing food and supplies. Transportation in general would come to a sudden halt, including all types of shipping and delivery systems. Logistics would be disrupted for many months and possibly years.

Shielding or radiation hardening individual computers in a personal vehicle or piece of equipment to protect it from an EMP is expensive, costing up to several thousand dollars per device or component. Examples of vehicle and equipment protection include:
1. Personally operated vehicles such as cars, SUV's, motorcycles.
2. Fire Rescue and Emergency medical vehicles and equipment
3. Law enforcement vehicles
4. Transportation vehicles and equipment of all kinds
5. Small to medium sized portable power generating devices
6. Military hardware not already protected by radiation hardening components

Despite the foregoing, very little occurs to promote routine protection of vehicles and other equipment from such threats. One reason for this may be a shortfall in education for the public regarding these concerns. Another reason could be that those persons aware of the concerns perceive the threat having a relatively low probability of materializing. Yet another reason may be that, even for the those who consider the threat a realistic possibility, they do not have available realistically convenient devices and means for protecting their vehicles and equipment.

In at least the latter case, if not the others, a need exists for means for protecting vehicles from the reasonable but inchoate threat of an EMP, including such means for protecting said vehicles that is practical and workable in the everyday lives of members of the public.

### SUMMARY OF THE INVENTION

A protective shield 20, 120, 200 for a vehicle comprises a sealable bag adapted to completely cover major equipment such as vehicles 1. In a particular embodiment, shield 20, 120, 200 is fabricated from metallic fabric layer 503 sandwiched between protective layers 501, 505, that prevents EMP leakage from affecting vehicle 1 electronics. One or more closures 30, 300 enable separating shield 20, 120, 200 into components to facilitate handling and storage. Zipper lock 310 may couple to an embedded computer adapted to verify time and duration of usage. Resembling in one embodiment a commonplace car cover, shield 200 is flexible and light weight enough to fold and store when not in use, including stowing it in vehicle 1 during travel. In another embodiment, shield 20, 120 may comprise a structure into which vehicle 1 may be driven and sealed to optimize convenience and encourage usage thereof.

### BRIEF DESCRIPTION OF THE DRAWINGS

The novel features characteristic of the present invention are set forth in claims appended hereto. The invention itself, as well as a preferred mode of use and further objects and advantages thereof, will best be understood by reference to the following detailed description of one or more illustrative embodiments when read in conjunction with the accompanying drawings, wherein:

FIG. 1 shows a left side perspective of a particular embodiment of the present invention.

FIG. 2 illustrates a zipper path for a serpentine zipper used with the invention.

FIGS. 3A-4 illustrate another particular embodiment of the present invention.

FIGS. 5-6 detail a storm flap for protection of the zipper used with the present invention.

FIG. 7 illustrates yet another particular embodiment of the present invention.

FIGS. 8-10 show the steps in using the embodiment of FIG. 7.

FIGS. 11-12 detail structural supports for the embodiment of FIGS. 7-10.

FIGS. 13-15 show a method of deployment of the embodiment of FIGS. 7-12.

FIGS. 16-20 illustrate still another particular embodiment of the present invention, as well as its method of deployment and usage.

FIG. 21 details a suitable material for use with the present invention.

FIGS. 22-23B detail zipper lock and monitoring apparatus.

FIGS. 24-25 show flow diagrams detailing the process of zipper lock monitoring.

### DESCRIPTION OF A PREFERRED EMBODIMENT

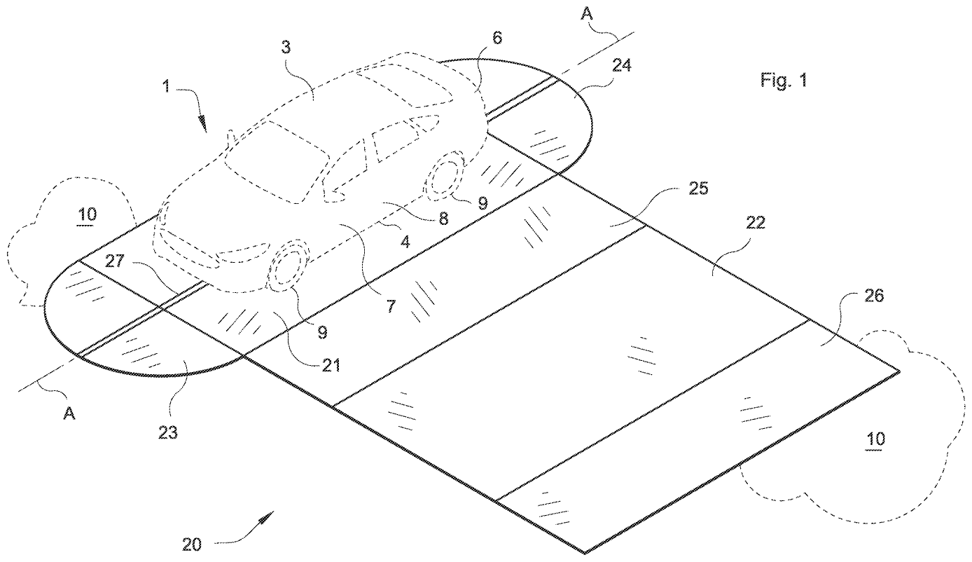

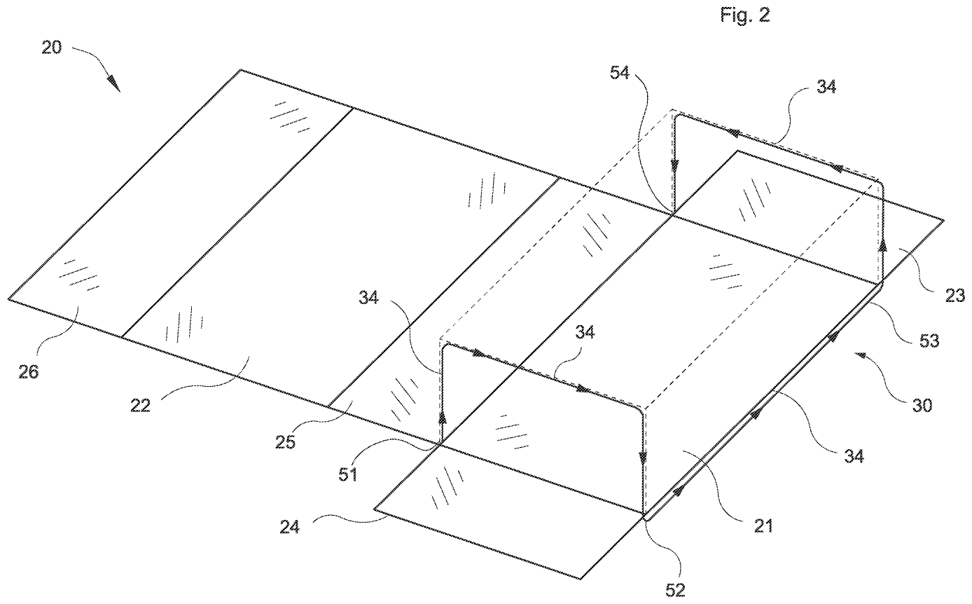

Referring now to the figures, and particularly to FIGS. 1-2, a particular embodiment of the present invention is shown in partial deployment for protection of vehicle 1. As illustrated, vehicle 1 represents a conventional passenger sedan of common configuration resting on its four wheels 9 atop base 21 of shield 20. Base 21 is disposed on substantially horizontal parking spot 10 such as a driveway, garage floor, platform or the like (none shown). Vehicle 1 as illustrated includes vehicle top, or roof 3, opposite vehicle bottom 4, vehicle front 5 and opposite vehicle rear 6 separated by vehicle longitudinal axis V, and vehicle left side 7 and opposite vehicle right side 8 substantially parallel to vehicle axis V.

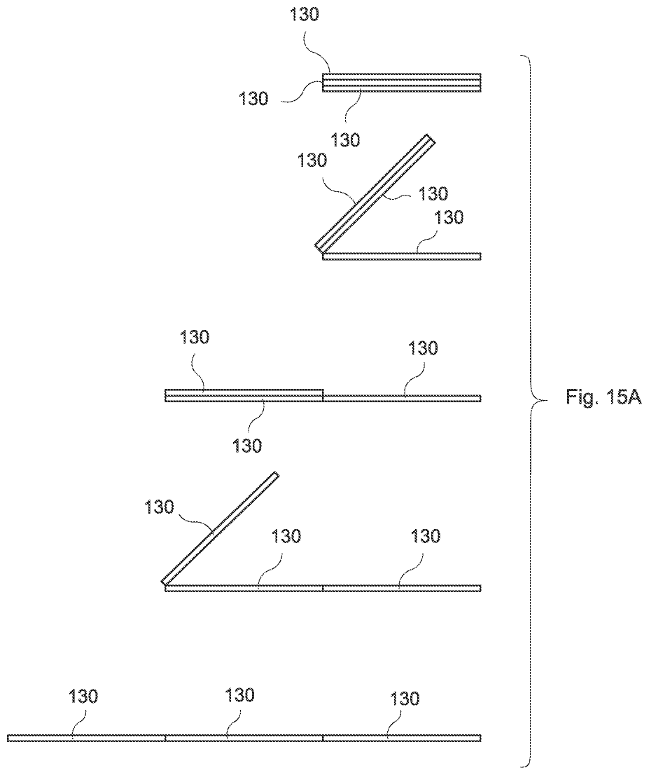

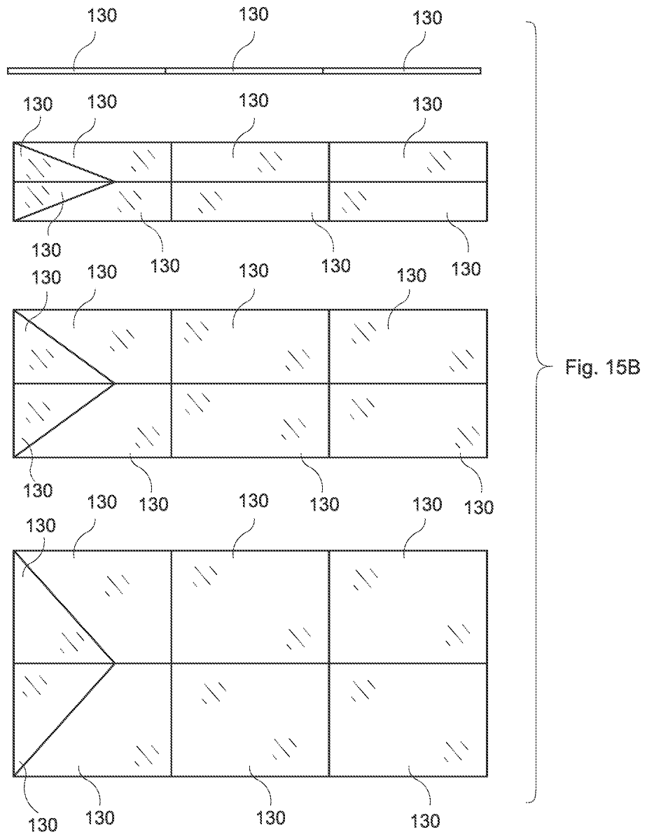

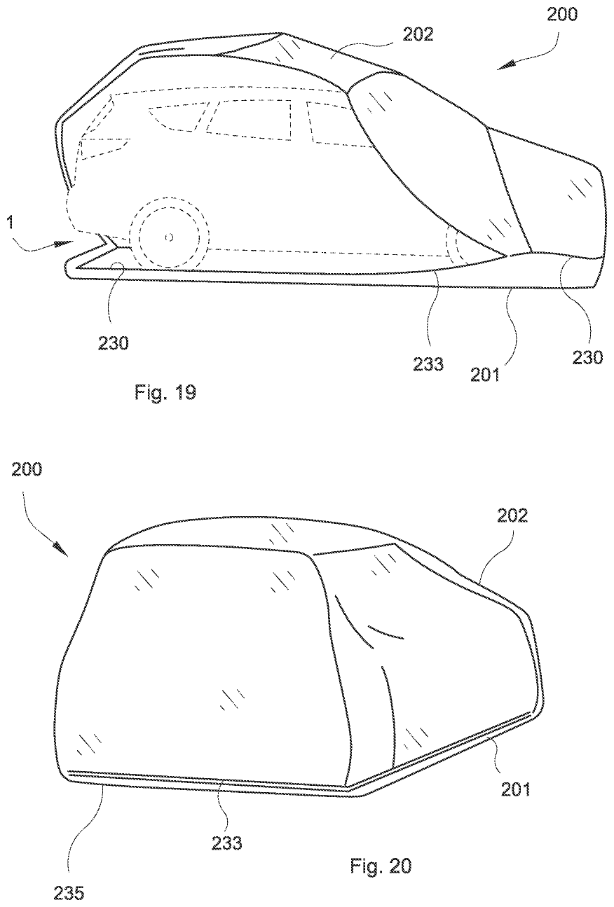

Vehicle 1 as used herein is intended to be interpreted in its broadest reasonable sense, and, with appropriate modifications to the invention to accommodate such vehicle 1 variations, can include a wide range of vehicle 1 sizes and shapes, including but not limited to pickups (e.g., see FIGS. 12, 14, 18, 19), sports utility vehicles (SUV's), golf carts, lawn mowers, motorcycles, bull dozers, train locomotives, helicopters, airplanes and water craft (none shown). One having ordinary skill in the art will recognize that all such variations of vehicle 1 are considered to be within the scope of the present invention.

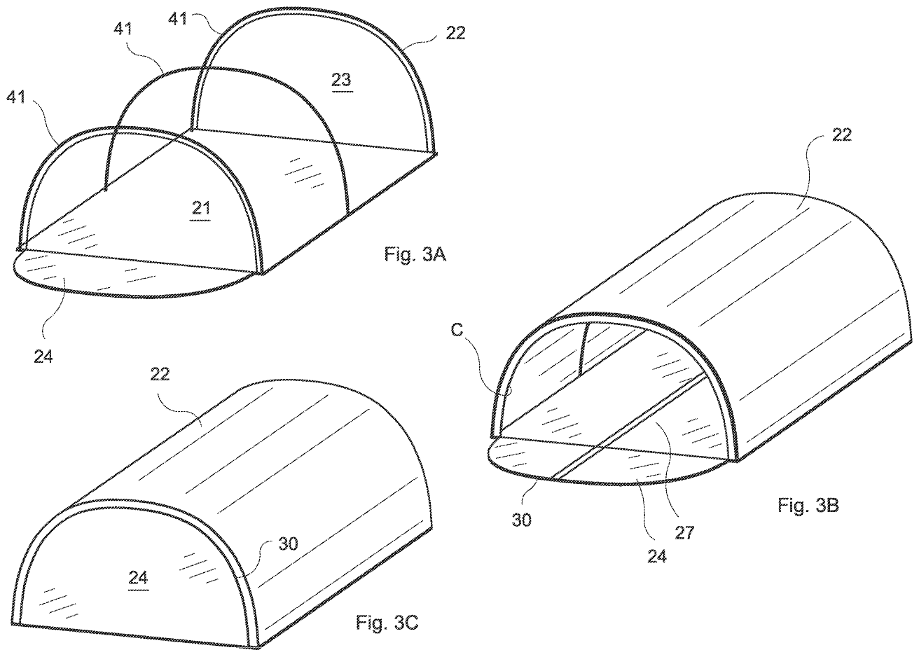

Electromagnetic pulse (“EMP”) resistant shield (hereinafter “EMP shield”, “shield” or “cover”) 20 includes several component panels coupled together, preferably with EMP-resistant seams as discussed in detail below. Base 21, upon which vehicle 1 rests as illustrated, comprises a substantially rectangular panel of fabric 500 having longitudinal axis A extending between front and rear end flaps 23, 24, corresponding to vehicle front and rear ends 5, 6, respectively. Base 21 further preferably has left and right side panels 25, 26 of fabric 500 corresponding to vehicle left and right sides 7, 8, respectively. End flaps 23, 24 as illustrated comprise substantially semi-ovate portions of material 500 sewn to opposite ends of base 21. When deployed (see FIGS. 3C-5), end flaps 23, 24 substantially cover and protect vehicle front 5 and vehicle rear 6. One having ordinary skill in the art will recognize that end flaps 23, 24 can have other shapes, such as semi-ovate, square or rectangular (see, e.g., FIG. 2) without departing from the scope of the present invention.

Disposed along the left side of base 21 between end flaps 23, 24, substantially rectangular, left side wall 25 extends the full length of base 21 and extends normal thereto away from base 21 a distance sufficient to protect vehicle left side 7 to its top or roof 3. Right side wall 26, preferably congruent with left side wall 25, is disposed a spaced distance away from and parallel to base 21. Coupling left and right side walls 25, 26, together and in substantially parallel disposition, roof portion 22 comprises a rectangular portion of material 500 substantially congruent with base 21.

### Alignment

Shield base 21 further may include alignment means serving as a guide for a driver (not shown) of vehicle 1 as said driver maneuvers vehicle 1 into position atop base 21 in preparation for deployment and use of shield 20. As depicted in the figures, said alignment means comprises longitudinal alignment stripe 27 extending equidistant between side panels 25, 26 along longitudinal axis A of base 21. Alignment stripe 27 may comprise a continuous straight line extending substantially the full length of base 21 and optionally (as shown) across one or both of end flaps 23, 24. Alignment stripe 27 may be applied to the upper surface of base 21 by any known means such as tape, ink or paint, but to preserve shield 20 integrity, preferably not stitched through base 21.

One having ordinary skill in the art will recognize, of course, that alignment stripe 27 may be a single, continuous or solid stripe or a plurality of stripes, and could comprise dashes or even short hash marks at either end of base 21 (neither shown) without departing from the scope of the present invention. Also, alignment means other than alignment stripe 27 may be employed, such as stanchions erected on base 21 or electronic sensors embedded within base 21 and detectable aurally or visibly by sensors within vehicle 1 (none shown).

Preparing to enclose vehicle 1 with shield 20, said driver or other personnel (neither shown) unfolds shield 20 and lays it out atop parking spot 10. Said driver then directs vehicle 1 onto base 21 across one of front end flap 23 or rear end flap 24. Said driver then exits vehicle 1 in anticipation of wrapping it with shield 20. With vehicle 1 in place atop base 21, its longitudinal axis V ideally is oriented parallel to base axis A and above alignment stripe 27.

### Closure

As best seen in FIG. 2, shield 20 further may include closure 30 extending around its entire perimeter. Closure 30 (see FIG. 6) is adapted to unite edges of various portions of shield 20 to form a cover over vehicle 1. Closure 30 is arrayed and arranged in a manner to form serpentine pathway 34 which enables said driver or other personnel to enclose vehicle 1 with shield 20 in one continuous motion. In a particular embodiment, closure 30 comprises zipper 33, as discussed in detail below. One having ordinary skill in the art will recognize, however, that closure 30 could instead comprise hook-and-loop fasteners (commonly known by the trade name Velcro) or other means (not shown) for removably adhering to each other two adjacent fabric layers without departing from the scope of the present invention.

Starting at first rear end corner S1 of base 21, where rear end flap 24 and left side wall 25 meet, closure 30 first mates left side wall 25, then roof portion 22 and then right side wall 26 to rear end flap 24, ending at second front end corner S2 of base 21. Next, closure 30 unites right side wall 26 to the right side of base 21, ending at a first front end corner S3 of base 21.

Thus, shield 20 forms chamber C (see FIG. 3B) between base 21, rear end flap 24, roof 22 and side walls 25, 26. Chamber C envelops vehicle 1 with its front end 5, corresponding to base 21's front end, with front end flap 23 remaining open. To close chamber C, closure 30 proceeds as indicated in FIG. 2 to unite front end flap 23 around its perimeter to a second front end corner S4 of base 21 where front end flap 23 and left side wall 25 meet. To un-deploy shield 20 for storage or transportation, the above steps may be performed in reverse, resulting in shield 20 being laid out on parking spot 10 as shown in FIG. 1 in preparation for folding. Vehicle 1 then can be moved and shield 20 folded up for storage.

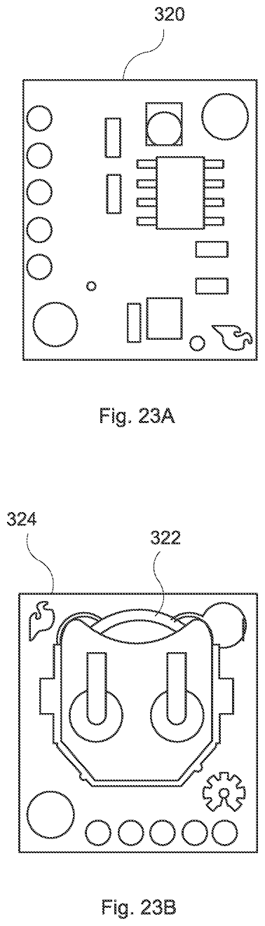

As best seen in FIGS. 5, 6, closure 30 comprises zipper 33 covered by storm flap 35, and deployed to prevent EMP leakage into chamber C through zipper 33. Storm flap 35 preferably is fabricated from the same shield fabric 500 as the rest of shield 20, as discussed in detail herein below. Storm flap 35 is disposed on both ends of side walls 25, 26 and roof 22 to cover zipper 33 while cover 20 is deployed. Storm flap 35 may be a continuation of an adjacent panel of shield 20 or it may be a separate strip attached to shield 20 along one or both sides and held closed over zipper 33 using a form of previously mentioned hook-and-loop strips. As discussed in more detail below with FIG. 22, closure 30 also may include electronic monitoring equipment to record, dates and times of deployment of cover 20.

Preferably, where hook-and-loop strips are employed to secure storm flap 35, they are fabricated from metallic material to prevent EMP leakage through them. Further, where closure 30 itself comprises hook-and-loop strips in lieu of zipper 33, closure 30 comprises such metallic hook-and-loop strips. A suitable metallic hook-and-loop product is available as Shieldex from V Technical Textiles, Inc., of Newark, New Jersey USA.

### Supports

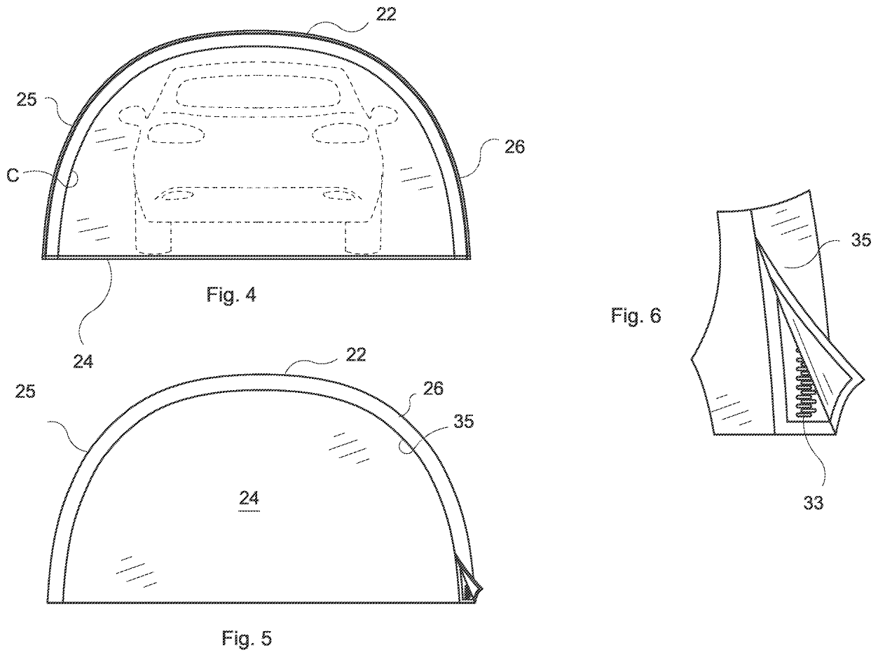

As discussed above, shield 20 can serve its purpose as described. Turning now also to FIGS. 3A-4, however, an optional variation to shield 20 includes structural support struts 41 which elevate side walls 25, 26 and roof 22 so that shield 20 is isolated from touching vehicle 1 and enabling vehicle 1 to be driven into and out of chamber C while shield 20 remains deployed. Support struts 41 as illustrated comprise resilient, fiberglass support rods similar to those known and available with portable camping tents. Such rods preferably are highly flexible and segmented, the segments held together by internal, elastic cords and end sockets (neither shown) to form a specific length of supports 41 easily collapsible into shorter segments (not shown) for storage with cover 20.

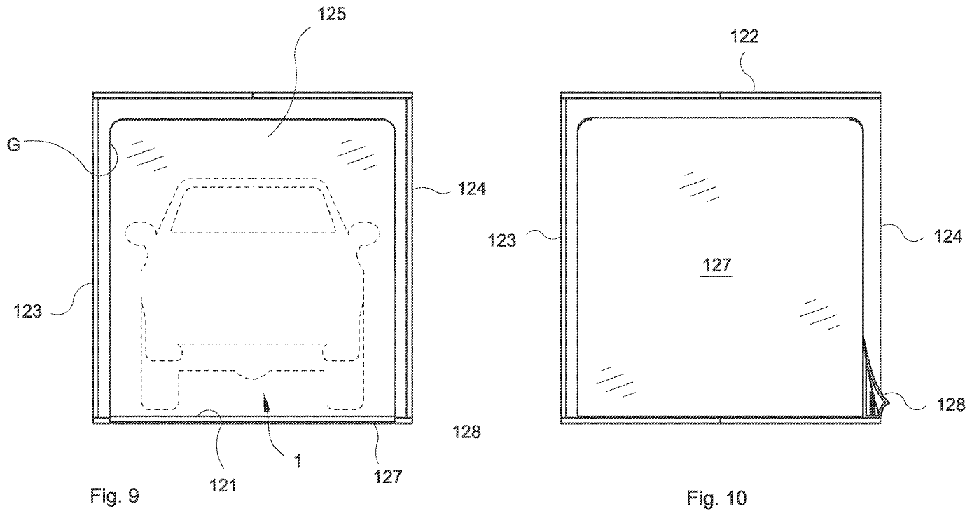

When deployed as shown in FIGS. 3A-5, struts 41 of multiple segments span above and transverse axis A to form cover 20 into a semi-ovate, Quonset hut shaped, cylindrical shelter extending along axis A. One having ordinary skill in the art will recognize, of course, that other shapes could be formed by differently configured supports 41 and remain within the scope of the present invention. For example, as illustrated in FIGS. 8-12 and discussed in more detail below, support struts 41 could be configured to form chamber G with a square, rectangular or other cross section.

### Stand-Alone Shelter

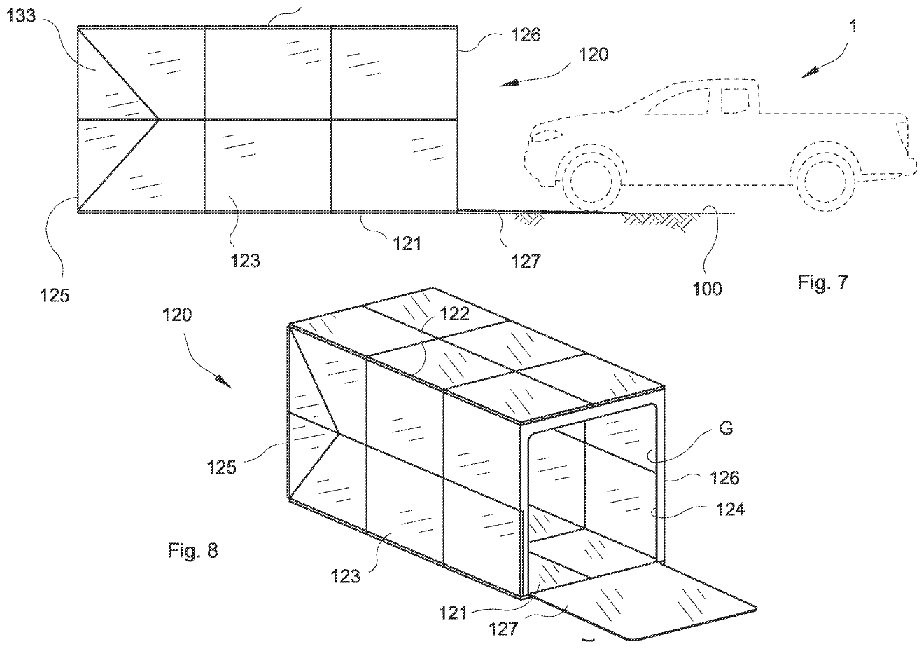

Turning now also to FIGS. 7-15B, another particular embodiment of the present invention comprises shelter 120 constructed from shield material 500 to achieve protection for vehicle 1 but with greater convenience. Shelter 120 may be erected, as described below, in a stationary location and vehicle 1 periodically driven into its interior G, requiring only that its open rear end 126 be sealed against EMP damage. This obviously provides a more convenient EMP shield than using shield 20, which, at least without the use of struts 41, likely must be erected each time it is used. A substantially permanent parking spot 100 for shield 120 may comprise a corner of a residential property or parking garage (neither shown) where shelter 120 (as well as shield 20 having struts 41) may protect vehicle 1 not only from EMP damage but also from other environmental elements just like any other garage. Alternatively, shelter 120 can be sized small enough to be erected within a permanent garage structure (not shown), where it is protected from such environmental elements but supplements said garage with EMP shielding without substantial modifications to said garage.

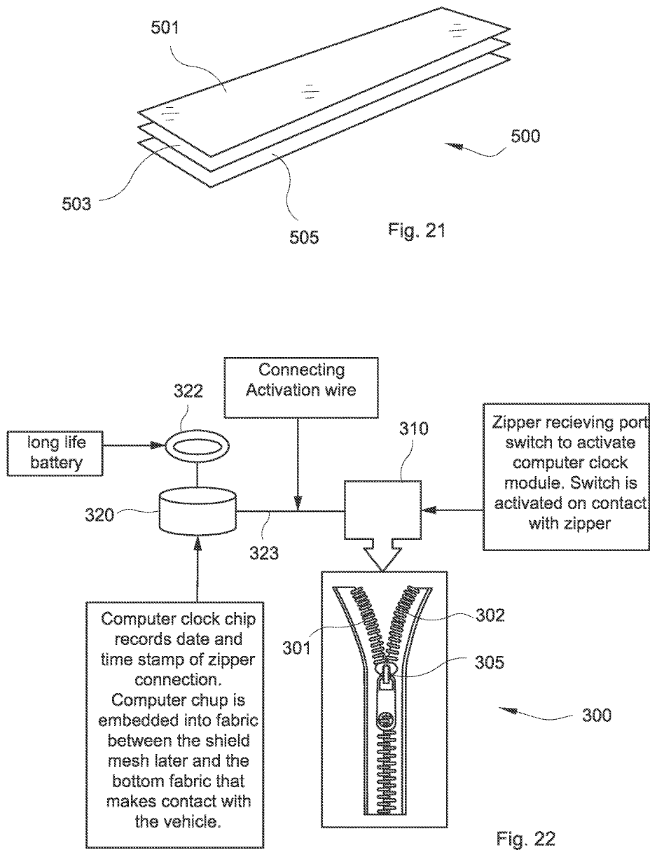

Shelter 120 comprises a single expanse of shield material 500 sufficiently large to cover the entirety of shelter floor 121, left and right side walls 123, 124 and roof 122 and having a shelter length at least longitudinally great enough to shield vehicle 1 end-to-end. Further, shield material 500 (FIG. 21) may extend beyond said shelter length enough to overlap itself and be folded to close front end 125, permanently affixing triangular tails 133 to left and right sidewalls 123, 124 in lieu of a front end flap (not shown) and corresponding zipper 128. One having ordinary skill in the art will recognize, of course, that a front door flap (not shown) substantially identical to rear door flap 127 could be employed instead of tails 133 without departing from the scope of the invention.

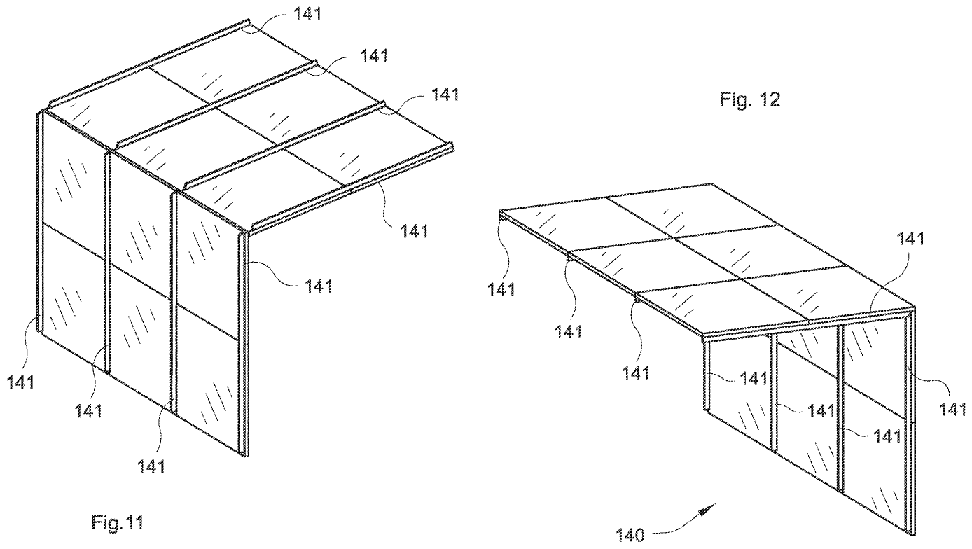

Segmented support struts 140 (FIGS. 11, 12) erected to form interior G stretch said shield material 500 into a stable cross-sectional shape sufficient to encompass vehicle 1 without material 500 touching vehicle 1. Preferably, of course, interior G is sized sufficiently large to permit a driver (not shown) of vehicle 1 to exit vehicle 1 within interior G, enabling said driver to simply drive into interior G, exit vehicle 1 using its side doors onto floor 121, step out rear end 126 of shelter 120 and seal it using door flap 127 and zipper 129. This obviates the need to exit vehicle 1 before driving it into interior G and then pushing vehicle 1 manually into interior G, something not every driver could do for many types of vehicles 1 as discussed above.

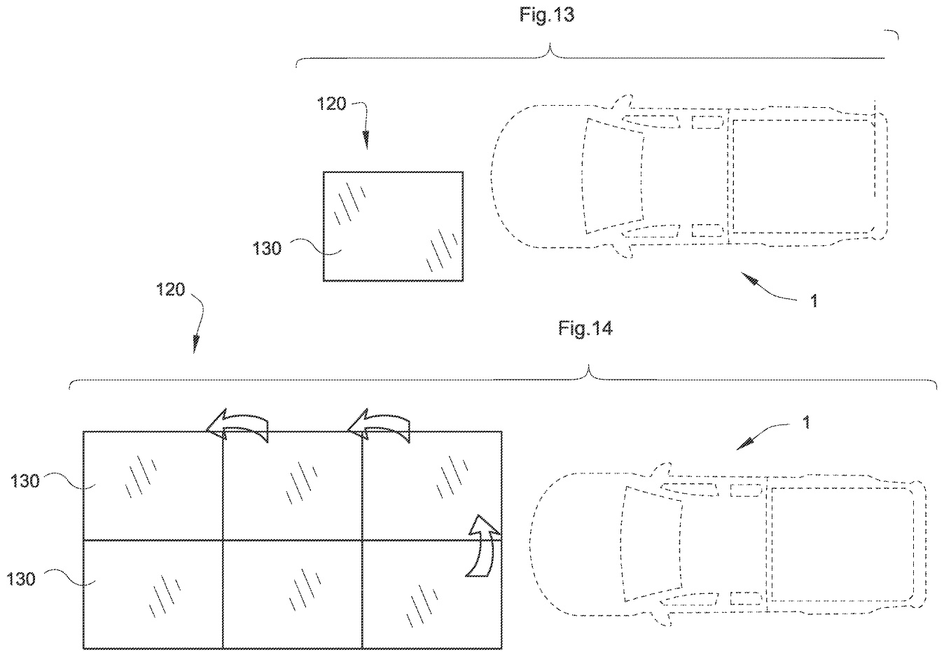

Support struts 140 comprise a plurality of segmented rods 141 of a length selected to create a folded package when shelter 120 is broken down for storage or transportation. See FIGS. 13-15. As depicted, segmented rods 141 divide shield material 500 into rectangular panels substantially half the height of left and right side walls 123, 124. This defines floor 121 and roof 122 as having substantially the same width as the height of side walls 123, 124, thus making front and rear ends 125, 126 substantially square. One having ordinary skill in the art will recognize that such dimension could vary within the scope of the present invention.

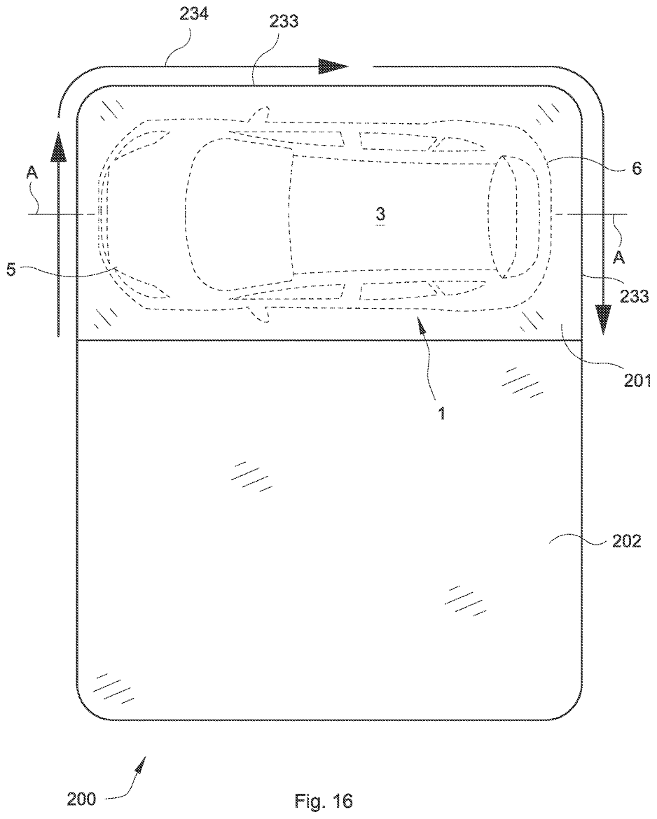

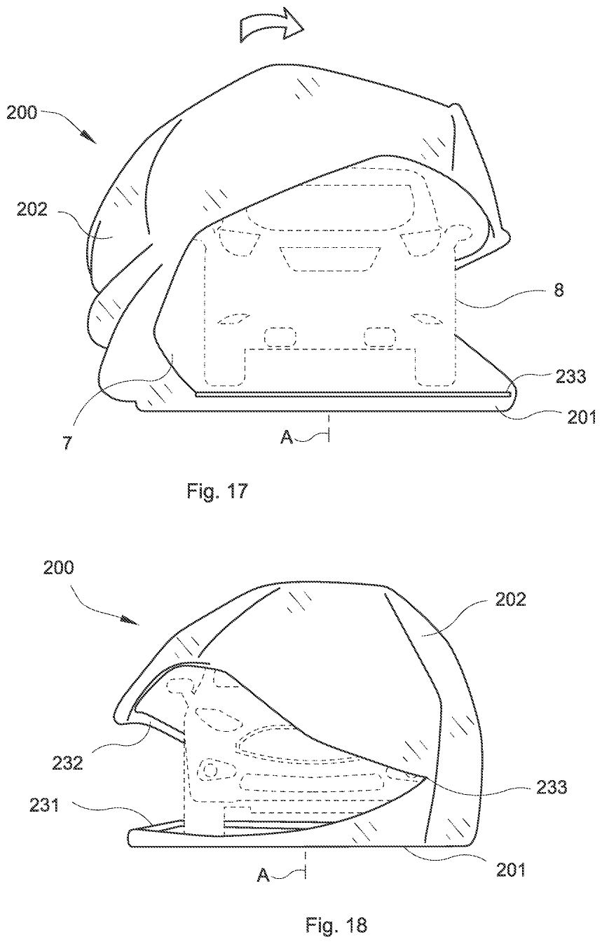

Segmented rods 141 couple together with locking hinges 143 which enable a user (not shown) to affix angles between rods 141 in order to vary the shape of shelter 120. For example, at a minimum, locking hinges 143 enable said user to lock rods 141 into linear alignment to double the length of one rod 141 segment. See FIGS. 16, 17. Hinges 143 also can affix two segments of rod 141 into a right angle relative to one another, so as to create the intersection of roof 122 with a wall segment 123, 124. This would limit the shape of shelter 120 to having a rectangular or square cross section, as depicted in FIGS. 12-15. Hinges 143 also should be capable of bends in both directions, to facilitate folding, as illustrated in FIGS. 16, 20.

One having ordinary skill in the art will recognize, however, that hinges 143 also may be capable of locking segments of rod 141 into other angles, such as forty-five (45 deg.) degree angles, to create other cross sectional shapes of shelter 120. For example, roof 122, though shown in the figures as flat, could have a ridge peak (not shown) using 45 degree angled hinges 143 at the corners where walls 123, 124 intersect roof 122. Similarly, using thirty (30 deg.) degree hinge angles, roof 122 could be made to resemble a barn roof (not shown). One having ordinary skill in the art will understand that all such configurations are considered to be within the scope of the invention.

Continuing with FIGS. 13-15, shelter 120 can be folded, using hinges 143 to form a compact “stack” of shelter panels 130 juxtaposed to one another to form shelter 120 as discussed above. Further, shelter 120 can be unfolded and deployed by a single person from a stack of panels 130 to erect shelter 120 without the need to zip them together, as discussed above for shield 20.

### Shielded Car Cover

Turning now also to FIGS. 16-20, a simplified and modified variation of shield 20 comprises car cover 200 having no end flaps. Instead, end flaps 23, 24, side walls 25, 26 and roof 22 are subsumed into single, substantially dome-shaped canopy 202 adapted to zip directly to base 201 using shortened closure 230, preferably in the form of zipper 233. As shown in sequence beginning with FIG. 16, once cover 200 is laid out onto parking spot 10 with canopy 202 stretched out to one side, a user (not shown) parks vehicle 1 atop base 201. As described for shield 20, base 201 may included alignment means such as stripe 27 to assist said user in doing so.

Said user then drapes canopy 202 over vehicle top 3 with its free right canopy side reaching down to lie adjacent to the right side of base 201. Said user then begins at the front of vehicle 1 and closes canopy 202 to base 201 along three sides, ending at the left rear corner of base 201, completely enveloping vehicle 1 inside cover 200 with one relatively simple closing motion. As best seen in FIG. 20, storm flap 235 covers zipper 233 to prevent EMP leakage reaching vehicle 1 through zipper 233, as discussed above for zipper 33.

As best seen in FIG. 20, cover 200 substantially fits the shape and size of vehicle 1, and may comprise panels reflect the contours of vehicle 1, similarly to car covers (not shown) commonly available to protect vehicle 1 from normal environmental conditions such as sunlight, rain and dust. Cover 200 further can accomplish all these goals while also shielding vehicle 1 against EMP damage because of the use of closure 230 and material 500 (FIG. 21) for the fabric of cover 200. Further, because it is smaller and comprises less material than shield 20, cover 200 more easily may be folded and carried in vehicle 1 for use at any location where vehicle 1 may be parked. Though similar convenience is true for shield 20, especially without segmented supports 41 (discussed herein above with FIG. 3B), cover 200 takes up less space in vehicle 1 and is somewhat simpler to deploy.

### Shielding Fabric

Continuing now also with FIG. 21, the fabric of shields 20, 120, 200 preferably comprises substantially flat, three-ply, EMP resistant web 500 panels assembled to form the shelters described above. In a particular embodiment, web 500 includes outer layer 501 of suitable durable material adapted to protect vehicle 1 from environmental elements, middle layer 503 of electromagnetic shielding material for resisting EMP's and bottom layer 505 of anti-abrasive material such as a soft cloth for placement against vehicle 20 to protect it against abrasion. In another particular embodiment, outer layer 501 comprises an aluminized web also having electromagnetic shielding capabilities.

As best seen in FIG. 1, bottom layer 505 of bases 21, 121, 201 is disposed upward, toward vehicle bottom 4 when vehicle 1 is positioned atop them. In a particular embodiment, bases 21, 121, 201 may not include bottom layer 505 of anti-abrasive material, but instead include another lamination of outer protective layer 501, resulting in middle, shielding layer 503 being sandwiched between two such protective layers 501. This would mitigate any damage from vehicle 1 driving atop bases 21, 121, 201 and provide a preferable surface onto which to apply alignment stripe 27 or other alignment means.

Electromagnetic middle shielding layer 503 preferably comprises a web of woven military grade nickel copper mesh preferably having a thickness of three (3 mil) mils (0.08 mm) and thread spacing sufficient to achieve at lease sixty (60 dB) decibel attenuation of an EMP in the ten (10 MHz) megahertz to three (3 GHz) gigahertz frequency range. A suitable shielding layer 503 material is available as CYBER NC-1 Military Grade Faraday Shield Fabric from Faraday Defense Corp. of Kalamazoo, Michigan USA.

In another particular embodiment, middle layer 503 instead may comprise a sheet of polyester film (biaxially-oriented polyethylene terephthalate, or PET, commonly known by the trade name Mylar). In still another particular embodiment, web 500 may comprise PET alone, without protective layer 501, and with or without anti-abrasion layer 505. One having ordinary skill in the art will recognize that layer 503 may comprise other EMP-resistant thread spacings and thicknesses, dependent upon the type and wavelength of EMP anticipated, without departing from the scope of the present invention.

Shielding layer 503 also may be grounded to an external grounding lug (not shown) which bleeds off any accumulated charge on said shielding layer induced by an EMP. One having ordinary skill in the art will recognize, however, that a shield with no electrical penetrations that admit EMP leakage need not be grounded. This is particularly true of portable shields 20, 200, which serve more as Faraday bags than more stationary shield 120, which might benefit more from grounding.

### Seams

As the figures indicate, various embodiments 20, 120, 200 of the invention discussed above require portions of web 500 (FIG. 21) cut into various panels (e.g. end flaps 23, 24, base 21, side panels 25, 26, and top 22) for shield 20. Said panels must be joined together at their respective edges to form sturdy, EMP-resistant seams (not detailed). To achieve this, the edges of said panels may be overlapped and stitched in conventional manner using cotton (or other suitable fiber) thread. Alternatively, and to increase said seam's EMP-resistivity, electrically conductive thread may be used where necessary to penetrate and secures said seams. A suitable conductive thread is available as model HC-40 from MadeiraUSA of Gilford, New Hampshire USA. Said seams also may be double or triple stitched for strength and integrity.

Seams further may be sealed with a seam sealant, which can be applied after said stitching. Such seam sealant preferably comprises a flowable, viscous substance that cures to a flexible, durable, water-proof layer also having electrical constituents which provide EMP resistance where web 500 may have been penetrated. A suitable seam sealant is PX 101MA Copper Gasket Sealant available from ITW Permatex of Solon, Ohio, USA.

Alternately, said seams may be covered with single or double coated metallic tapes, rubber based adhesives and transfer adhesives. A suitable double-coated, metallic tape is available as Model No. 3200 from Holland Shielding Systems BV of Dordrecht, The Netherlands. Said seams preferably also may be ultrasonically sealed together.

### Monitored Closure

Turning now to FIGS. 22-25, closure 300 comprises a version of closure 30 having additional safety and monitoring features. Specifically, closure 300 detects and logs when a user (not shown) employs any of shield/shelters 20, 120 or 200 to protect vehicle 1. This can be valuable in cataloging whether shield/shelter 20, 120, 200 has been compromised by being opened without authorization. It also can provide evidence for, inter alia, insurance settlement purposes, that shield/shelter 20, 120, 200 in fact was in use if vehicle 1's electronics suffered damage from an EMP.

Closure 300 is structurally substantially similar to closure 30. In a particular embodiment, it includes left and right zipper teeth structures 301, 302 adapted to be mated in a closed position and unmated in an open position by longitudinal movement of carriage 305, as with conventional zippers well known in the art. Closure 300 however includes locking port 310 coupled to computer clock chip 320 which locks closure 300 closed and logs when closure 300 is closed, how long it remains closed and when it is opened again. Zipper locking port 310 includes locking means 311 which secures closure 300 in a closed and locked state after vehicle 1 has been enclosed within shield 20, 120, 200 and closure 300 closed, as discussed in detail above. Zipper locking port 310 assures that closure 300 has not been tampered with while vehicle 1 ostensibly has been protected.

As best seen in FIGS. 23A, 23B, processor 320 includes clock board 322 powered by battery module 324 and embodies software adapted to carry out steps 600, discussed below, for engaging integrity monitoring of closure 300, including logging the dates and times of changes in status of closure 300 from closed to open. Processor 320 preferably is embedded (not shown) within shelter material 500 (FIG. 21) between shielding layer 503 and inner, bottom cloth layer 505, thus being disposed within the protection of shield/shelter 20, 120, 200.

In a particular embodiment, shielded cable 323 couples the foregoing, discrete components together. In another particular embodiment, components 310, 320 and 322 reside together on a single circuit board, which, in yet another particular embodiment may be enclosed within a metal box (not shown) or other shielding means and disposed within shields 20, 120, 200. One having ordinary skill in the art will recognize that any combination of solid-state component structure capable of achieving closure 300 is considered within the scope of the present invention.

### Procedure

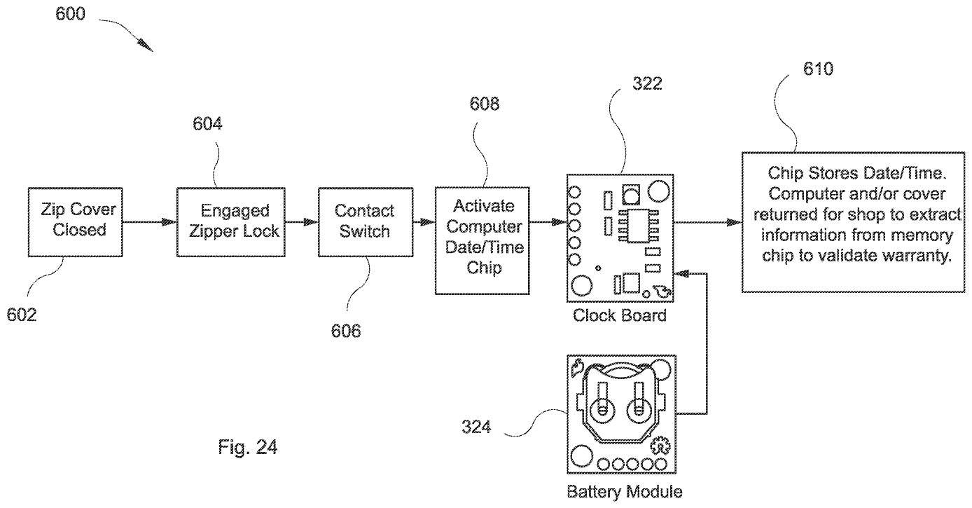

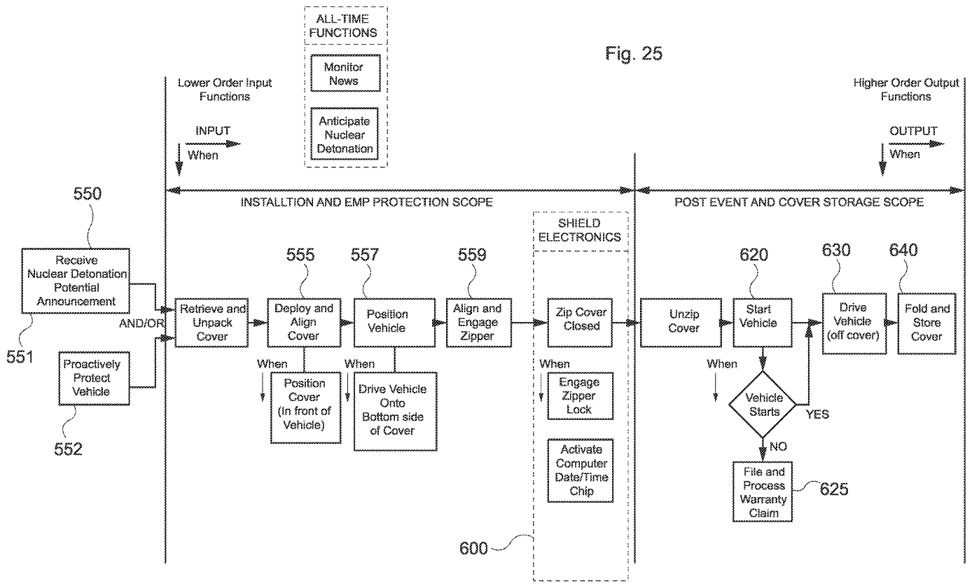

Referring now particularly to FIGS. 24, 25, steps 600 detail implementation of the integrity monitoring capability of shield 20, 120, 200. A user (not shown), while effectively monitoring situational awareness, may be alerted 551 to an anticipated emergency or, alternatively, prospectively may wish to protect 552 vehicle 1 as a precaution. In either case, said user deploys 555 shield 20, 120, 200 to surround 557 vehicle 1 and engage 559 closure 300 as discussed above.

In particular, said user zips up 559 closure 300 as discussed above in conjunction with FIG. 2. Upon reaching second front end corner S4, said user has closed 602 shield 20, 120, 200 and established shielded chamber C, G enclosing vehicle 1. Said user then locks 602 zipper locking port 310 as discussed above, thereby engaging 606 a contact switch (not shown) which activates 608 clock chip 320 which then monitors 610 the status of zipper locking port 310 until the system is disengaged in preparation for opening chamber C, G, probably in anticipation of using vehicle 1.

Upon opening chamber C, G, said user then tests the success of shield 20, 120, 200 in maintaining electronics integrity by attempting to operate 620 vehicle 1. If it starts and runs properly, all is well, and the user drives 630 vehicle 1 off of shield 20, 120, 200, and secures 640 shield 20, 120, 200 for later use, as discussed above separately for each of shields 20, 120, 200. If vehicle 1 does not start, said user investigates the reason and, if shield 20, 120, 200 has failed, as evidenced by damaged vehicle 1 electonics, said user reports 625 that fact to authorities (probably an insurance provider) for repair and compensation.

### SUMMARY

As discussed, shield 20, 120, 200 thus may be deployed rapidly, or employed regularly, to prevent damage to vehicle 1 from an EMP. If shield 20, 120, 200 does not include closure 300 for monitoring enclosures C, G integrity, shield 20, 120, 200 still protects vehicle 1 as long as it is deployed correctly and used consistently. Further, if shield 20, 120, 200 is outfitted with closure 300, a record of said user's diligence can be maintained for securing repair and compensation should shield 20, 120, 200 fail despite said user's efforts to protect his vehicle 1.

While the invention has been particularly shown and described with reference to preferred and alternate embodiments, it will be understood by those skilled in the art that various changes in form and detail may be made therein without departing from the scope of the invention.

For example, use and benefits of shield 20, 120, 200 are discussed above in the context of protecting movable vehicle 1. Similarly, other equipment, stationary or not, such as electronics cabinets, indoor and outdoor computer facilities, portable laptops and tablets, could benefit from shield 20, 120, 200 with concomitant resizing and shape configurations appropriate for the equipment to be protected. Further, shield 20, 120, 200 is discussed above for enclosing the entirety of vehicle 1, but portions of vehicle 1 instead could be isolated and insulated from EMP's following the principles describe herein. Also, cover support means for supporting shields 20, 120 above but not touching vehicle 1 has been characterized as internal support struts 41, 141, but instead could be tethers attached between shields 20, 120 and external frames spanning above shields 20, 120 or to the ceiling and walls of a garage (neither shown).

Still further, shield 20, 120, 200 is discussed above for protecting vehicle 1 electronics from EMP hazards, but also serves as a shield from other environmental threats such as wind, blowing sand, and even animal invasions of vehicle 1, the latter often resulting in damage to the animal (cats sleeping on warm engines) and vehicle 1 (rats chewing hoses and insulation).

1. A vehicle protective shield, said vehicle having a longitudinal axis extending between a vehicle front end and a vehicle rear end, said vehicle further having a vehicle bottom, a vehicle top, a vehicle left side and a vehicle right side substantially parallel to said longitudinal axis, said vehicle protective shield comprising
a base adapted to be disposed beneath said vehicle bottom, said base having a base top adjacent said vehicle bottom and an opposite base bottom; a base longitudinal axis extending between a base front end and a base rear end; and base left and right sides extending parallel to and on opposite sides of said base longitudinal axis; said base front and rear ends and said base left and right sides defining a base perimeter having a base perimeter length;
a cover coupled to said base and having a cover perimeter congruent with said base perimeter; and
a closure coupled between said base perimeter and said cover perimeter and adapted to unite said base and said cover to form a chamber having a chamber interior adapted to receive and enclose at least a portion of said vehicle; wherein
said base and said cover are fabricated from an electromagnetic pulse resistant fabric.

2. (canceled)

3. The vehicle protective shield of claim 2 and further comprising
at least one protective layer disposed coextensive with said electromagnetic pulse resistant fabric.

4. The vehicle protective shield of claim 2 and further comprising
an anti-abrasion inner layer disposed on said cover between said electromagnetic pulse resistant fabric and said vehicle.

5. The vehicle protective shield of claim 1 wherein said base further comprises
alignment means for aligning said vehicle on said base.

6. The vehicle protective shield of claim 5 wherein said alignment means comprises
at least one visible stripe disposed on said base top parallel to said base longitudinal axis.

7. The vehicle protective shield of claim 1 wherein said closure further comprises
a zipper extending along at least a portion of said base perimeter and said cover perimeter, said zipper adapted to articulate between
a closed chamber position uniting said base and said cover perimeters; and
an open chamber position whereby said vehicle may be directed into and out of said chamber; and
a zipper flap coupled to one of said base perimeter and said cover perimeter, said zipper flap extending coextensive with said zipper and overlapping said zipper and another one of said base perimeter and said cover perimeter.

8. The vehicle protective shield of claim 7 and further comprising
at least one metallic hook-and-loop strip disposed between said zipper flap and one of said base perimeter and said cover perimeter.

9. The vehicle protective shield of claim 7 and further comprising
a zipper lock and monitor embedded within said cover and electrically coupled to said zipper between said base perimeter and said cover perimeter, said zipper lock and monitor having
a lock adapted to lock said zipper into said closed chamber position; and
a processor adapted to monitor and record a date, a time and a duration of time during which said zipper is locked in said closed chamber position.

10. The vehicle protective shield of claim 1 and further comprising
at least one end flap coupled to said base at one of said base front end and said base rear end; and
zipper means coupled between said at least one end flap and said cover, said zipper means adapted to open said chamber for providing access to said chamber interior.

11. The vehicle protective shield of claim 1 and further comprising
a plurality of support struts disposed a spaced distance apart along and transverse to said base longitudinal axis, said support struts supporting said cover and forming said chamber into a self-supporting shelter for said vehicle.

12. The vehicle protective shield of claim 11 wherein each of said support struts further comprises
a plurality of strut segments, each of said plurality of strut segments coupled end-to end with at least one other of said plurality of strut segments; and
hinge means coupled between adjacent ones of said plurality of strut segments, said hinge means adapted to affix said adjacent ones of said plurality of strut segments at a select angle relative each other.

13. The vehicle protective shield of claim 11 wherein each one of said plurality of support struts further comprises
a plurality of resilient strut segments coupled end-to end, said each one of said plurality of support struts extending in an arch above said base between said base left and right sides;
5 whereby said plurality of support struts form said chamber into a cylinder of substantially semi-ovate cross section along said base longitudinal axis.

14. The vehicle protective shield of claim 1 wherein said base and said cover comprise
a plurality of fabric panels stitched together to form a plurality of linear seams having a seam length and a seam width; and
said linear seams are sealed with an electromagnetic pulse resistant seal.

15. The vehicle protective shield of claim 14 wherein said pulse resistant seal comprises
a metallic tape disposed atop said protective outer layer and extending along said seam length, said metallic tape having a metallic tape width at least as wide as said seam width.

16. A vehicle protective shield for a vehicle having a vehicle longitudinal axis extending between vehicle front and rear ends, said vehicle further having vehicle bottom, top, left and right sides substantially parallel to said vehicle longitudinal axis, said protective shield comprising
a base having a base top adjacent said vehicle bottom and an opposite base bottom; a base longitudinal axis extending between base front and rear ends; and base left and right sides extending on opposite sides of said base longitudinal axis; said base front and rear ends and base left and right sides defining a base perimeter having a base perimeter length;
a cover coupled to said base and having a cover perimeter congruent with said base perimeter; and
a zipper coupled to said base perimeter and said cover perimeter and adapted to unite said base and said cover to form a chamber having a chamber interior adapted to receive and enclose at least a portion of said vehicle, said zipper articulating between a closed chamber position and an open chamber position;
a zipper flap coupled to one of said base said cover perimeters and overlapping said zipper and said other one of said base cover perimeters; and
a zipper lock and monitor for monitoring said zipper to record a date, a time and a duration of time during which said zipper is in said closed chamber position;
wherein said base and said cover are fabricated from a web of fabric having an electromagnetic pulse resistant layer and a protective layer disposed coextensive with said electromagnetic pulse resistant layer opposite said vehicle.

17. The vehicle protective shield of claim 16 and further comprising
a plurality of support struts disposed a spaced distance apart along and transverse to said base longitudinal axis, said support struts supporting said cover and forming said chamber into a self-supporting shelter for said vehicle.

18. The vehicle protective shield of claim 16 wherein said base further comprises
at least one alignment stripe disposed on said base top parallel to said base axis.

19. A method of protecting a vehicle, said vehicle having a vehicle longitudinal axis extending between a vehicle front end and a vehicle rear end, said vehicle further having a vehicle bottom, a vehicle top, a vehicle left side and a vehicle right side substantially parallel said vehicle longitudinal axis, said method comprising
providing a vehicle protective shield having
a base having a base longitudinal axis extending between base front and rear ends; base left and right sides extending on opposite sides of said base longitudinal axis; wherein said base front and rear ends and base left and right sides define a base perimeter having a base perimeter length;
a cover coupled to said base and having a cover perimeter congruent with said base perimeter; and
a closure coupled to said base perimeter and said cover perimeter and adapted to unite said base and said cover to form a chamber having a chamber interior adapted to receive and surround said vehicle; then
deploying said vehicle protective shield with said base disposed atop a vehicle parking location; then
directing said vehicle to a parked position atop said base with said vehicle longitudinal axis substantially parallel to and above said base longitudinal axis; then
operating said closure to enclose said vehicle within said chamber;
wherein
said base and said cover are fabricated from a web of electromagnetic pulse resistant fabric.

20. (canceled)

21. The method of claim 19 wherein said vehicle protective shield further comprises
at least one end flap coupled to said base at one of said base front and rear ends; and
zipper means coupled between said at least one end flap and adapted to open said chamber for providing access to said chamber interior.

22. The method of claim 19 wherein said closure comprises
a zipper extending along at least a portion of said base perimeter and said cover perimeter, said zipper adapted to articulate between a closed chamber position and an open chamber; and
a zipper flap coupled to one of said base perimeter and said cover perimeter, said zipper flap extending coextensive with said zipper and overlapping said zipper and said other one of said base perimeter and said cover perimeter.

23. The method of claim 19 wherein
said vehicle protective shield further comprises
zipper lock and zipper monitoring means for locking said zipper into said closed chamber position; and monitoring said zipper to record a date, a time and a duration of time during which said zipper is in said closed chamber position; and
said operating step further comprises
locking said zipper; then
recording a start date and start time when said chamber is closed; then
recording an end date and an end time when said chamber is next opened; then comparing said start date and said start time and said end date and said end time with known electromagnetic pulse events; and
reporting any electromagnetic pulse damage.
